(19) United States
(12) Patent Application Publication
(10) Pub. No.: US 2008/0060953 A1
(43) Pub. Date: Mar. 13, 2008

(54) Modular assembly

(76) Inventor: Baghdadi Ghassan, Tokyo (JP)

Correspondence Address: Ladas & Parry, 26 West 61st Street, New York, NY, 10023, US

(21) Appl. No.: 11/895,995

(22) Filed: Aug. 28, 2007

Related U.S. Application Data
(60) Provisional application No. 60/841,145, filed on Aug. 30, 2006.

(30) Foreign Application Priority Data
Aug. 30, 2005 (JP) 2005-250143

(51) Int. Cl. B65D 77/00; A45C 13/38; B62B 3/00; B65D 25/28

(52) U.S. Cl. 206/216; 190/15.1; 220/752; 280/29

(57) ABSTRACT

The present invention discloses a modular assembly including plural of unit storage members for storing an object therein. Each unit storage member substantially has six sides and eight corner parts. Each unit storage member includes a coupling mechanism having a male coupling member and a female coupling member dedicated to couple with the male coupling member. The plural unit storage members are coupled by having the male coupling member of one unit storage member coupled to the female coupling member of another unit storage member situated adjacent to the one unit storage member. Among sets of three sides that form each of the corner parts of the unit storage member, each unit storage member includes a first corner part formed by having one male coupling member provided on one side and one female coupling member provided on each of the other two sides and a second corner part formed by having one female coupling member provided on one side and one male coupling member provided on each of the other two sides. The first and second corner parts are arranged in a manner having coupling members of the same kind positioned diagonally opposite to each other.

### BACKGROUND OF THE INVENTION

1. Field of the Invention

The present invention generally relates to a modular assembly, and more particularly to a modular assembly used by combining plural unit storage members.

2. Description of the Related Art

In general, a bag, such as a suitcase, has a storage part for storing an object therein. Thus, conventionally, since the volume of a storage part of a bag is defined beforehand, a conventional bag may not be able to store an object(s), for example, in a case where the object is too large or where there are too many objects. Therefore, it becomes necessary to prepare another bag for storing the object(s) and carry plural bags. However, carrying plural bags can be inconvenient.

Furthermore, the amount of content may vary depending on the usage/purpose of the bag. For example, the amount to be stored in a bag during a business trip is usually different from the amount to be stored in a bag during a leisure vacation. Therefore, a bag capable of storing only a single fixed amount cannot be used for such multiple purposes.

Accordingly, Japanese Examined Utility Model Application No. 6-42487, for example, discloses a modular bag that couples plural storage members together for solving the aforementioned problem.

By coupling plural storage members together, the storage amount of the bag can be arbitrarily set. However, such conventional modular bags capable of coupling plural storage members are subject to various constraints such as a coupling part (e.g., zipper) or a configuration which merely connects an inserting coupling member and a receiving coupling member to the side of a target object. Due to these constraints, even if the modular bag can allow plural storage members to be coupled in a linear manner or a planar (two-dimensional) manner, the plural storage members cannot be coupled three-dimensionally.

Therefore, with the conventional modular bag, plural storage members cannot be coupled in a compact manner. Furthermore, even if the storable amount can be increased with the conventional modular bag, the coupled shape of the modular bag makes it difficult to carry.

### SUMMARY OF THE INVENTION

The present invention may provide a modular assembly that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a modular assembly particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a modular assembly including plural unit storage members for storing an object therein, each unit storage member substantially having six sides and eight corner parts, each unit storage member including a coupling mechanism having a male coupling member and a female coupling member dedicated to couple with the male coupling member, wherein the plural unit storage members are coupled by having the male coupling member of one unit storage member coupled to the female coupling member of another unit storage member situated adjacent to the one unit storage member, wherein among sets of three sides that form each of the corner parts of the unit storage member, each unit storage member includes a first corner part formed by having one male coupling member provided on one side and one female coupling member provided on each of the other two sides and a second corner part formed by having one female coupling member provided on one side and one male coupling member provided on each of the other two sides, wherein the first and second corner parts are arranged in a manner having coupling members of the same kind positioned diagonally opposite to each other.

Furthermore, another embodiment of the present invention provides a modular assembly including plural unit storage members for storing an object therein, each unit storage member including a coupling mechanism having a male coupling member and a female coupling member dedicated to couple with the male coupling member, wherein the plural unit storage members are coupled by having the male coupling member of one unit storage member coupled to the female coupling member of another unit storage member situated adjacent to the one unit storage member, wherein at least one of the male coupling member and the female coupling member has a cord-like shape having one end connected to the one unit storage member and the other end detachably connected to the other unit storing member.

Other objects and further features of the present invention will be apparent from the following detailed description when read in conjunction with the accompanying drawings.

### BRIEF DESCRIPTION OF THE DRAWINGS

FIG. 1 is a schematic diagram for describing a principle of a modular assembly according to a first embodiment of the present invention;

FIG. 2 is a schematic diagram showing a unit storage member of a modular assembly according to the first embodiment of the present invention;

FIG. 3 is a developed view showing a unit storage member according to the first embodiment of the present invention;

FIGS. 4A and 4B are schematic diagrams showing a detailed example of a modular bag according to the first embodiment of the present invention;

FIGS. 5A-5E are schematic diagrams showing a coupling mechanism provided in a unit storage member according to the first embodiment of the present invention;

FIG. 6 is a schematic diagram showing an example of coupling a pair of unit storage modules by using a coupling mechanism according to the first embodiment of the present invention;

FIG. 7 is a schematic diagram showing a state where a pair of unit storage modules is coupled by using a coupling mechanism according to the first embodiment of the present invention;

FIGS. 8A-8C are schematic diagrams for describing an operation between a male coupling member and a female coupling member of a coupling mechanism in a case of coupling a pair of unit storage members according to the first embodiment of the present invention;

FIGS. 9A and 9B are schematic diagrams showing a coupling mechanism according to another embodiment of the present invention;

FIGS. 10A-10E are schematic diagrams showing a coupling mechanism provided in a unit storage member according to another embodiment of the present invention;

FIG. 11A-11C are enlarged views of the coupling mechanism shown in FIGS. 10A-10E;

FIGS. 12A and 12B are schematic diagrams for describing a male coupling member of the coupling mechanism shown in FIGS. 10A-10E;

FIGS. 13A and 13B are schematic diagrams for describing a female coupling member of the coupling mechanism shown in FIGS. 10A-10E;

FIG. 14 is a schematic diagram showing a state where the male coupling member shown in FIGS. 12A-12B is coupled to the female coupling member shown in FIGS. 13A-13B;

FIGS. 15A-15D are schematic diagrams for describing a handle according to an embodiment of the present invention;

FIG. 16 is a schematic diagram for describing a configuration of a joint part for connecting a grip part and a support part according to an embodiment of the present invention;

FIGS. 17A-17C are schematic diagrams for describing a handle according to another embodiment of the present invention;

FIG. 18 is a schematic diagram showing a detailed example of a modular bag according to the second embodiment of the present invention;

FIG. 19 is a schematic diagram showing a unit storage member of a modular assembly according to the second embodiment of the present invention;

FIG. 20 is a schematic diagram showing a coupling mechanism provided in a modular assembly according to the second embodiment of the present invention;

FIGS. 21A and 21B are schematic diagrams for showing an example of coupling a pair of unit storage modules by using a coupling mechanism according to the second embodiment of the present invention; and

FIGS. 22A and 22B are schematic diagrams for showing a state where a pair of unit storage modules is coupled by using a coupling mechanism according to the second embodiment of the present invention.

### DESCRIPTION OF THE PREFERRED EMBODIMENTS

In the following, embodiments of the present invention will be described with reference to the accompanying drawings.

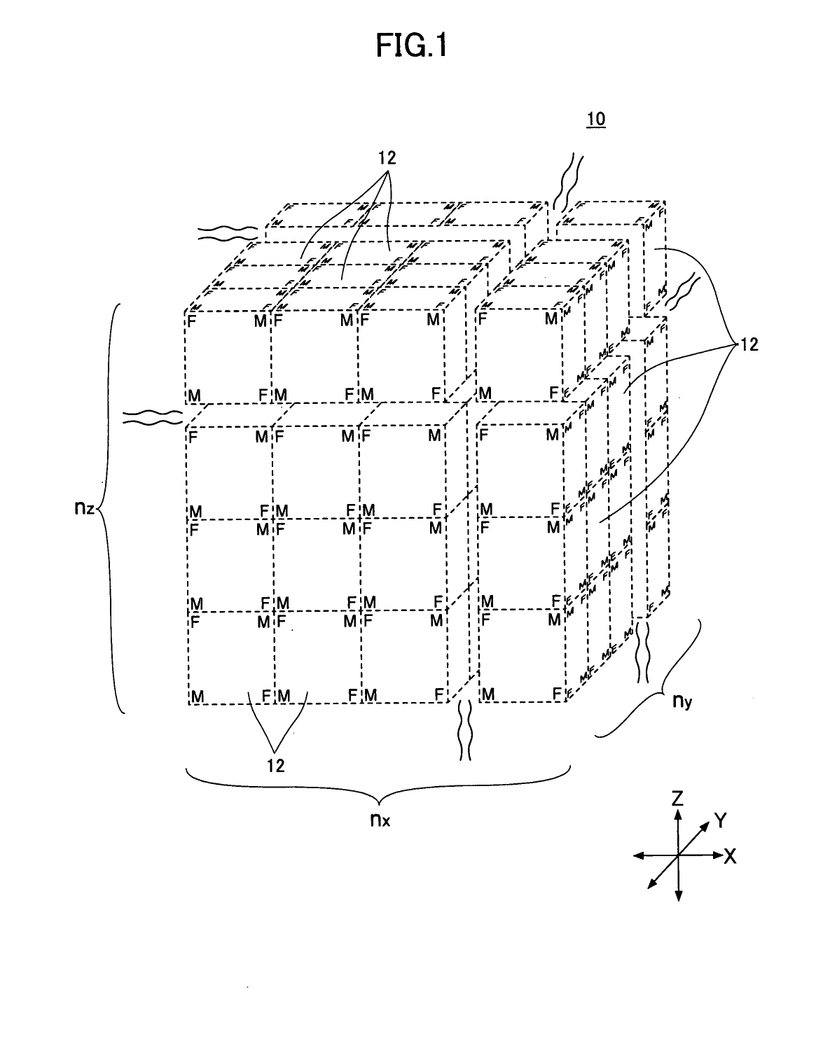

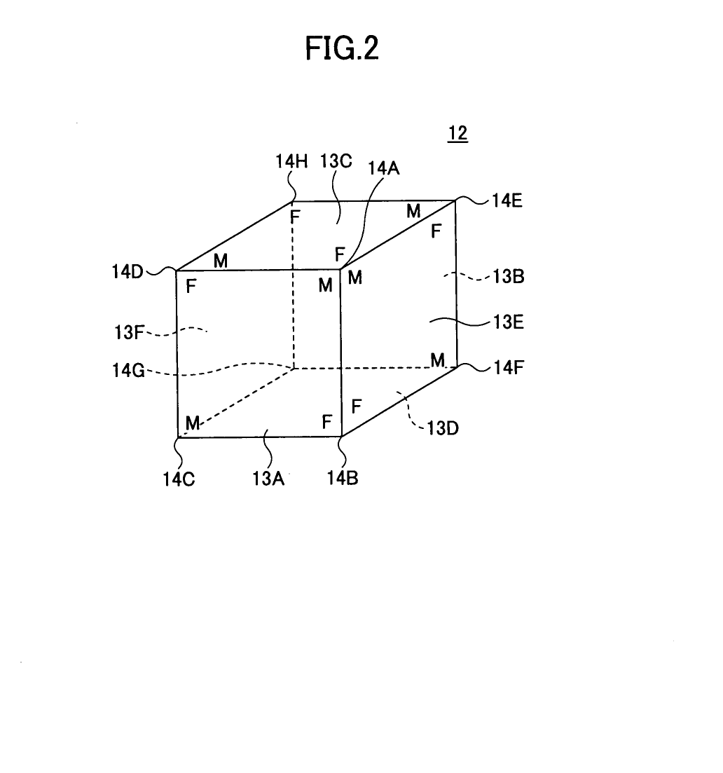

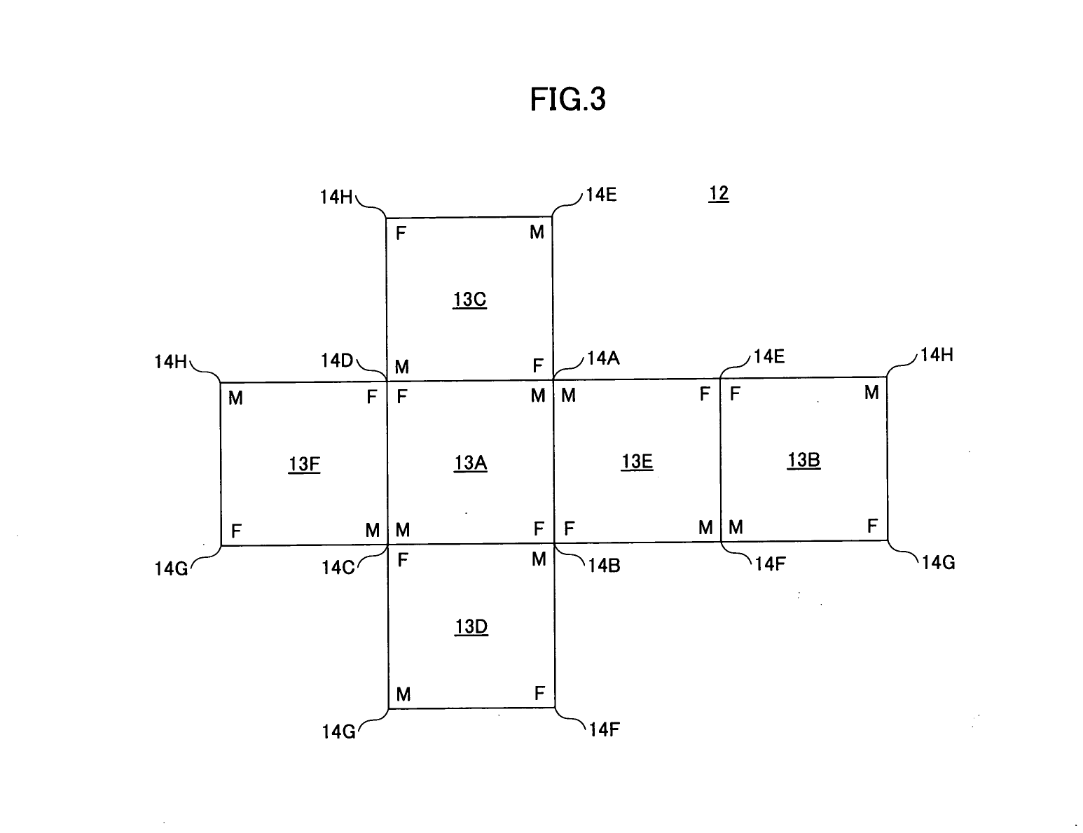

FIGS. 1 to 3 are schematic diagrams for describing a modular assembly 10, such as a modular bag, according to a first embodiment of the present invention. More specifically, FIG. 1 is a schematic diagram for describing a principle of the modular assembly 10, and FIGS. 2 and 3 show a unit storage member 12 included in the modular assembly 10.

The modular assembly 10 is configured to be coupled in the X direction, the Y direction, and the Z direction, respectively (illustrated with arrows in FIG. 1). In other words, the modular assembly 10 is configured to three-dimensionally couple the unit storage member 12. The principle of three-dimensionally coupling the unit storage module 12 according to an embodiment of the present invention is described below.

The modular assembly 10 according to an embodiment of the present invention has a coupling mechanism 20 for coupling plural unit storage members 12 together. The coupling mechanism 20 includes a male coupling member 22 (also indicated as “M” in the drawings) and a female coupling member 24 (also indicated as “F” in the drawings). The male coupling member 22 and the female coupling member 24 are configured to be coupled to each other.

For the sake of convenience, the unit storage member 12 of this embodiment is described as having a cubic shape. Thus, as shown in FIGS. 2 and 3, the unit storage member 12 has a total of six sides (front plane part 13A, rear plane part 13B, a top plane part 13C, a bottom plane part 13D, a right plane part 13E, and a left plane part 13F). Furthermore, three sides (planes) of the unit storage member 12 form a corner part. Thus, in a case where the unit storage member 12 has a rectangular shape, eight corner parts (corner parts 14A-14H) are formed in the unit storage member 12. Although each of the unit storage members 12 used for a commonly used modular bag has a substantially rectangular shape, the unit storage member 12 may be modeled into a shape as shown in FIGS. 2 and 3.

Among the sets of three planes forming each of the corner parts 14A-14H of the unit storage member 12 of the modular bag 10, each unit storage member 12 includes a first corner part formed by having one male coupling member 22 provided on one plane and one female coupling member 24 provided on each of the other two planes and a second corner part formed by having one female coupling member 24 provided on one plane and one male coupling member 22 provided on each of the other two planes. More specifically, among the corner parts 14A-14H of the unit storage member 12 of this embodiment, first corner parts include the corner part 14B, 14D, 14E, and 14G whereas second corner parts include the corner part 14A, 14C, 14F, and 14H.

Furthermore, on each plane 13A-13F of the unit storage member 12 of this embodiment, the first and second corner parts are arranged in a manner having coupling members of the same kind (male vs. male or female vs. female) positioned diagonally opposite to each other. For example, with reference to the front plane part 13A shown in FIGS. 2 and 3, one first corner part (corner part 14D) is positioned opposite to another first corner part (corner part 14B) supposing that there is a diagonal line extending from the upper left to the lower right of the front plane part 13A. Furthermore, one second corner part (corner part 14A) is positioned opposite to another second corner part (corner part 14C) supposing that there is a diagonal line extending from the lower left to the upper right of the front plane part 13A.

With the unit storage member 12 having the above-described configuration according to an embodiment of the present invention, the male coupling member 22 is always positioned opposite to the female coupling member 24 in a case of three-dimensionally coupling plural unit storage members 12 next to each other as shown in FIG. 1 (in the example shown in FIG. 1, “n” unit storage members are coupled in X, Y, and Z directions, respectively). Therefore, a reliable coupling (engagement) can be ensured even in a case where plural unit storage members 12 are arbitrarily combined.

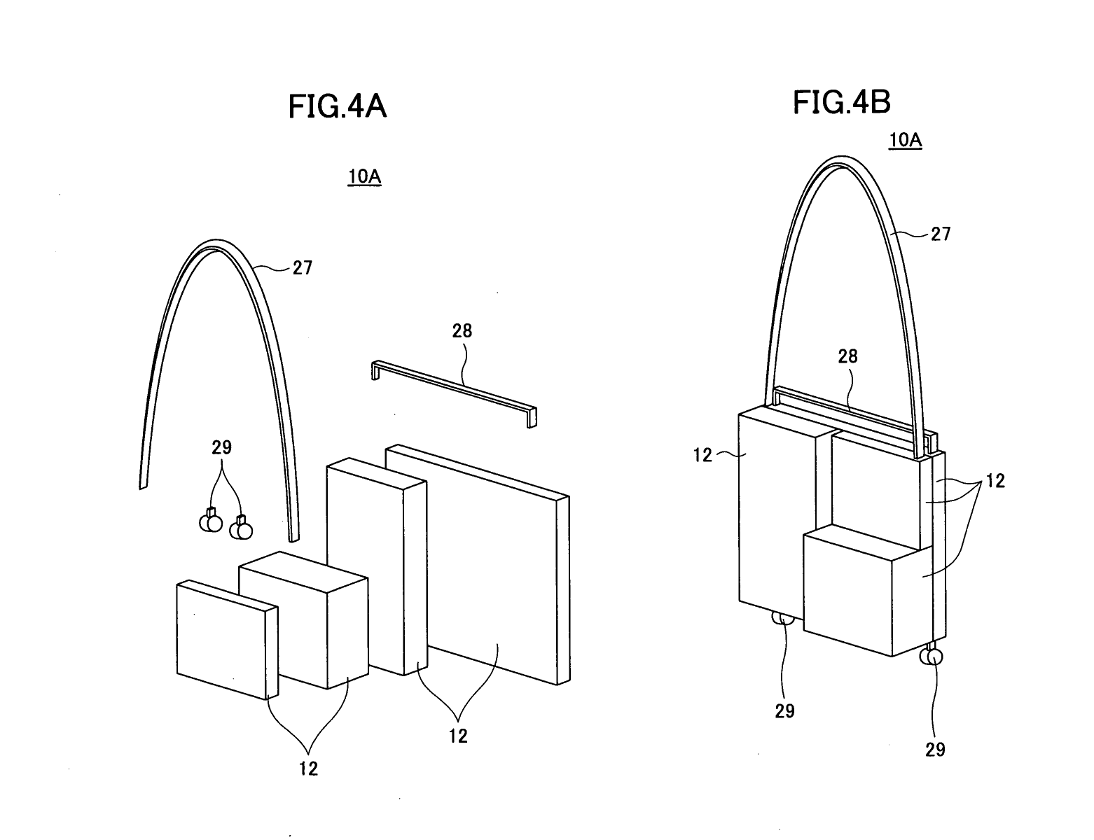

FIGS. 4A and 4B show a detailed example of a modular bag 10A to which the above-described principle is applied. FIG. 4A shows a state prior to coupling the modular bag 10A. As shown in FIG. 4A, four unit storage members 12 having different shapes are used in this example. As shown in FIG. 4B, the four unit storage members 12 are coupled together by the coupling mechanism 20 (male coupling member 22, female coupling member 24), to thereby form the modular bag 10A. As shown in FIGS. 4A and 4B, the usability of the modular bag 10A can be improved by coupling additional components (e.g., a shoulder belt 27, a handle 28, and/or rollers 29) to the modular bag 10A. As described below, the coupling mechanism 20 (male coupling member 22, female coupling member 24) may also be used at the coupling points between the modular bag 10A and the shoulder belt 27, the handle 28, and/or the rollers 29.

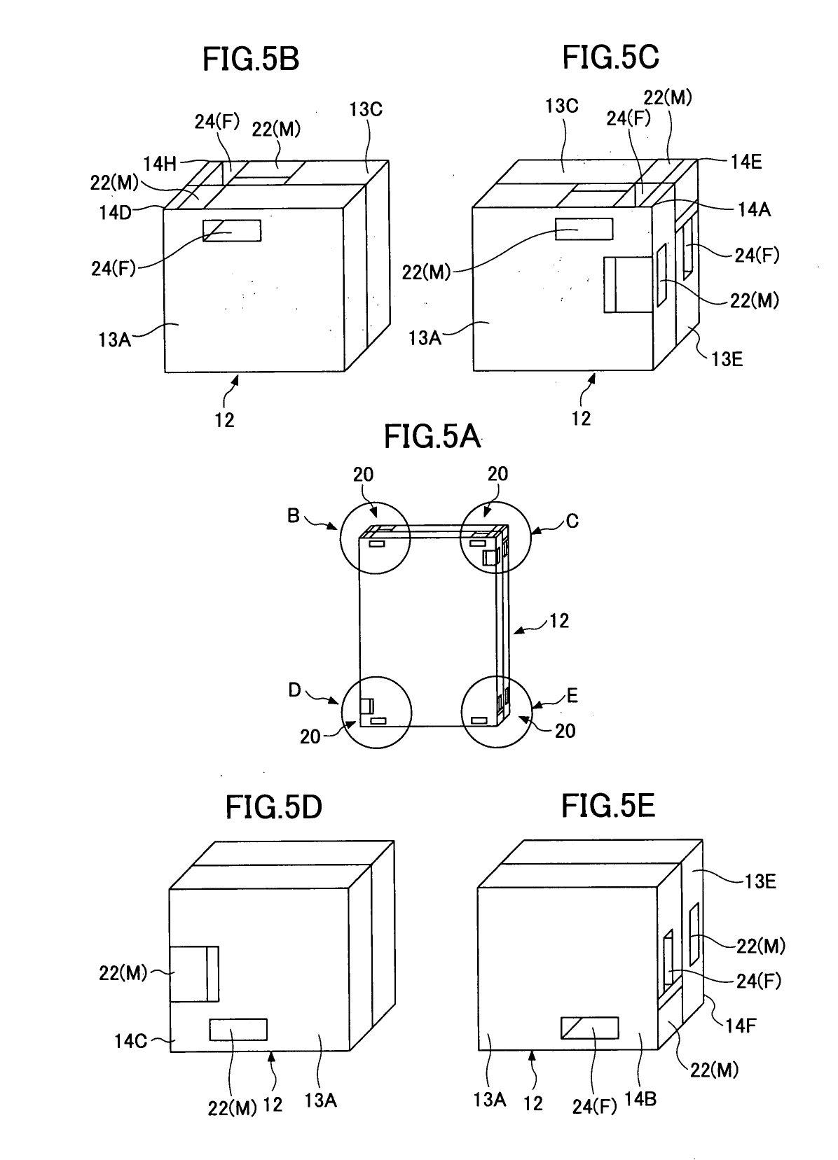

Next, the coupling mechanism 20 according to an embodiment of the present invention is described in further detail. FIGS. 5A through 8C show the coupling mechanism 20 applied to various embodiments of the present invention. FIG. 5A shows the unit storage member 12 using the coupling mechanism 20 according to an embodiment of the present invention. FIG. 5B is an enlarged view showing a portion of the unit storage member 12 indicated with an arrow B in FIG. 5A. FIG. 5C is an enlarged view showing a portion of the unit storage member 12 indicated with an arrow C in FIG. 5A. FIG. 5D is an enlarged view showing a portion of the unit storage member 12 indicated with an arrow D in FIG. 5A. FIG. 5E is an enlarged view showing a portion of the unit storage member 12 indicated with an arrow E in FIG. 5A.

The unit storage member 12 shown in FIG. 5A has the male coupling members 22 and the female coupling members 24 arranged in the same manner as described above with reference to FIGS. 2 and 3.

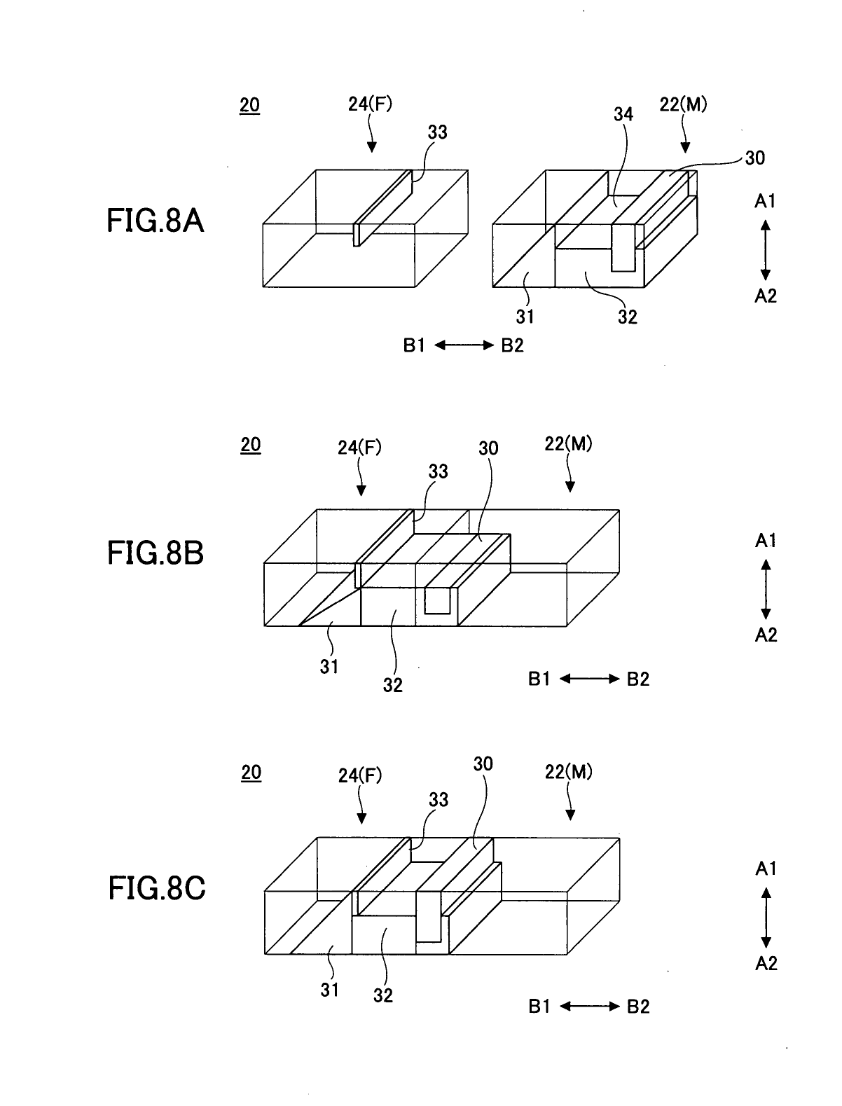

First, configurations of the male coupling member 22 and the female coupling member 24 according to an embodiment of the present invention are described with reference to FIGS. 8A-8C. As shown in FIG. 8A, the male coupling member 22 has a cantilevered arm part 32 having a pawl part 31 on one end and a knob part 30 on the other end.

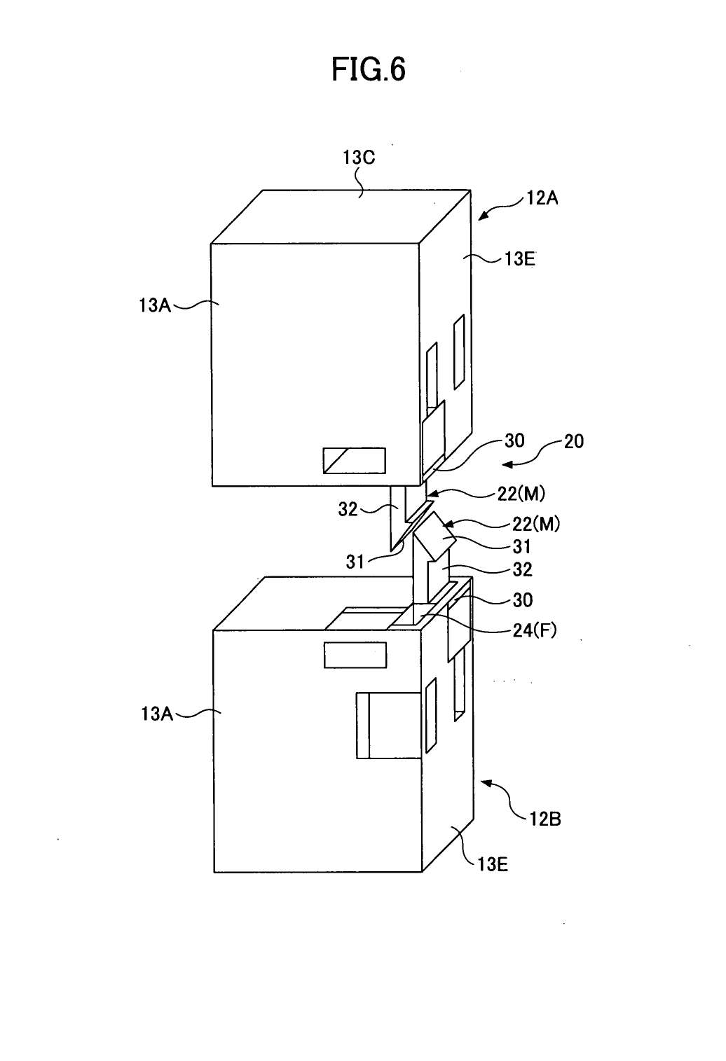

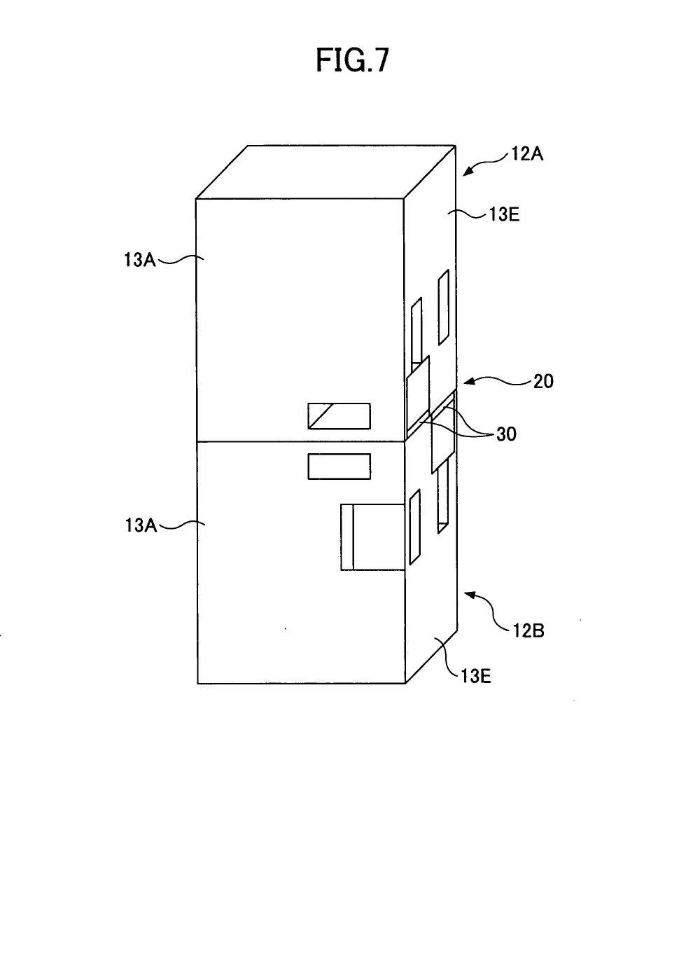

The knob part 30 is movable in directions A1 and A2 as well as directions B1 and B2 with respect to a base 34 provided inside the male coupling member 22. As shown in FIGS. 6 and 7, the knob part 30 is exposed outside of the unit storage member 12. That is, the knob part 30 can be operated (manipulated) from outside the unit storage member 12. On the other hand, the female coupling member 24 has a locking member 33 provided therein. The locking member 33 is for engaging the pawl part 31 (described in detail below).

Next, the operation (movement) for coupling the male coupling member 22 and the female coupling member 24 of the coupling mechanism 20 is described. In coupling the male coupling member 22 and the female coupling member 24, the male coupling member 22 and the female coupling member 24 are positioned facing each other. Then, the arm part 32 is moved in direction B1 while pressing the knob part 30 in direction A2. By pressing the knob part 30 in direction A2, the pawl part 31 is urged in the direction A2 via the arm part 32. Thereby, the pawl part 31 is allowed to pass under the locking member 33 and advance to the end of the female coupling member 24 (See FIG. 8B).

Then, when the pressing force applied to the knob part 30 is released, a spring member or the like (not shown) urges the knob part 30 in the direction A1, to thereby allow the knob part 30 to return to its original position. At the same time, the pawl part 31 is also moved in the direction A1. Accordingly, the pawl part 31 of the male coupling member 22 engages the locking member 33 of the female coupling member 24. The engaging force of the pawl part 31 and the locking member 33 allows the male coupling member 22 to be coupled to the female coupling member 24. It is to be noted that the coupling between the male coupling member 22 and the female coupling member 24 can be released by performing the above-described procedures in reverse.

FIG. 6 shows an example of using the above-described coupling mechanism 20 where a unit storage member 12A positioned at an upper part is coupled to another unit storage member 12B positioned a lower part. In FIG. 6, it is to be noted that the pawl part 31 is illustrated in a manner projecting out from the unit storage member 12 for making it easier to understand the configuration of the coupling mechanism 20.

In FIG. 6, the pawl part 31 of the unit storage member 12A is inserted and locked in the female coupling member 24 of the unit storage member 12B, and the pawl part 31 of the unit storage member 12B is inserted and locked in the female coupling member 24 of the unit storage member 12A. Thereby, as shown in FIG. 7, the unit storage member 12A and the unit storage member 12B are coupled one on top of the other. Although FIG. 6 shows the unit storage members 12A and 12B coupled to each other in the vertical direction, the unit storage members may also be coupled to each other in the X, Y, Z directions as shown in FIG. 1.

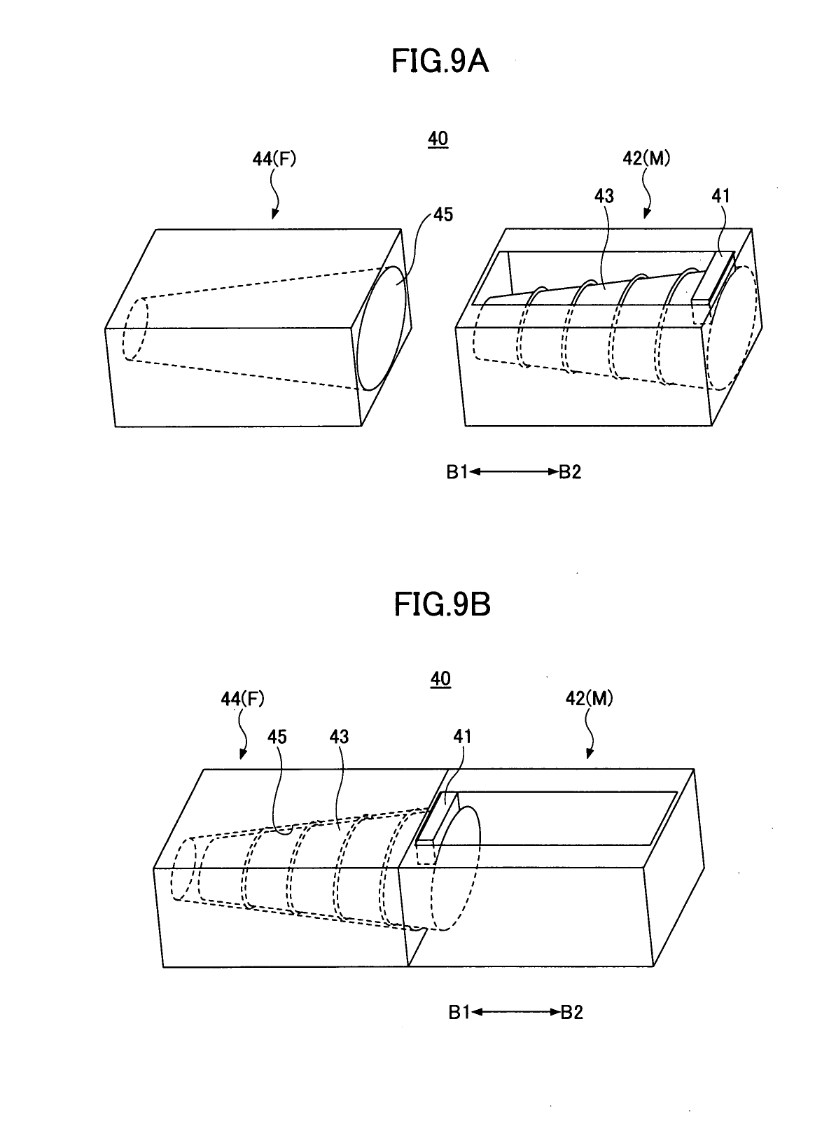

FIGS. 9A and 9B show a coupling mechanism 40 according to another embodiment of the present invention. The same as the above-described coupling mechanism 20, the coupling mechanism 40 is also formed in the unit storage member 12. The coupling mechanism 40 also has a male coupling member 42 and a female coupling member 44. The male coupling member 42 includes an insertion engagement member 43 which is movable in directions B1 and B2 (indicated with arrows in FIGS. 9A and 9B) by operating (manipulating) a knob part 41. The insertion engagement member 43 may also have one or more ring parts (formed of, for example, a rubber material) provided along its longitudinal direction. The insertion engagement member 43 is configured having a tapered shape. In this example, the insertion engagement member 43 has a conical shape having a cross-section that becomes smaller toward direction B1.

Meanwhile, the female coupling member 44 has an engagement opening 45. The opening 45 corresponds to the shape of the insertion engagement member 43. Thus, the engagement opening 45 has a conical shape having a cross-section that becomes smaller toward direction B1.

In the coupling mechanism 40, the male coupling member 42 and the female coupling member 44 are positioned facing each other. Then, the knob part 41 is moved in direction B1 to allow the insertion engagement member 43 to be inserted and engaged to the engagement opening 45. The engaging force between insertion engagement member 43 and the engagement opening 45 allows the male coupling member 22 to be coupled to the female coupling member 24. It is to be noted that the coupling between the male coupling member 22 and the female coupling member 24 can be released by performing the above-described procedures in reverse.

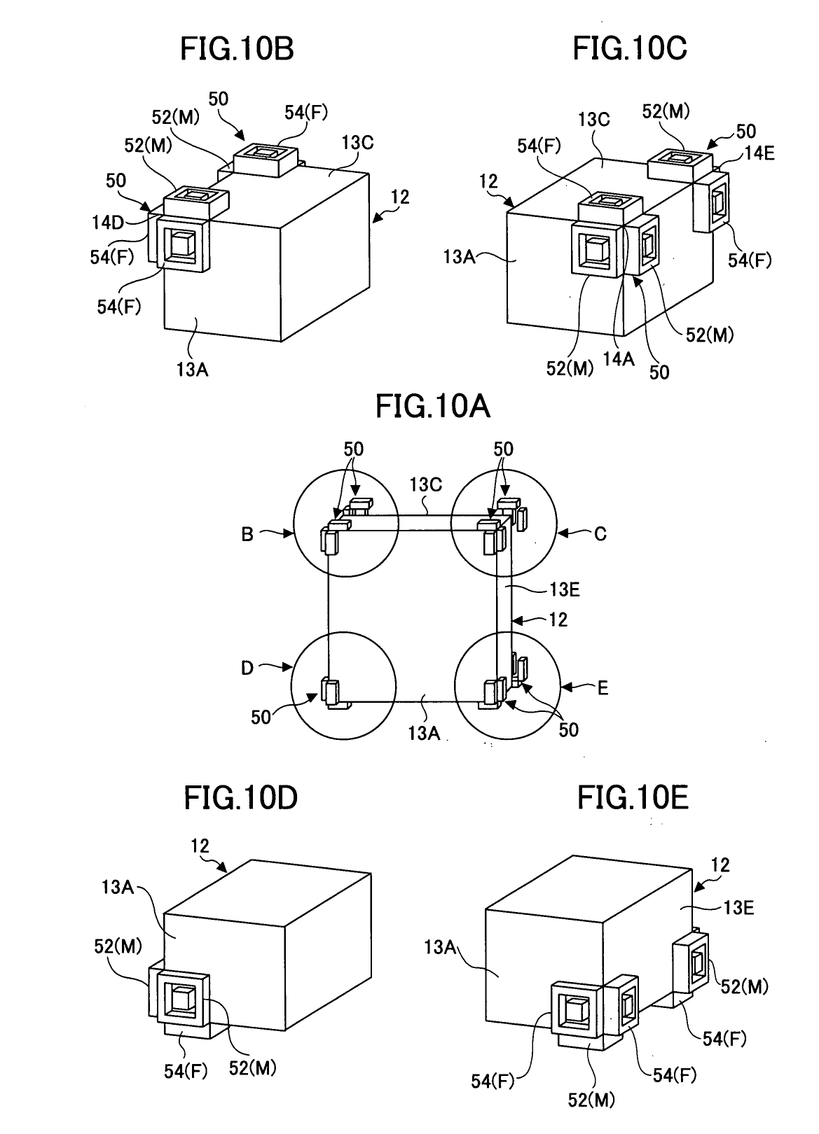

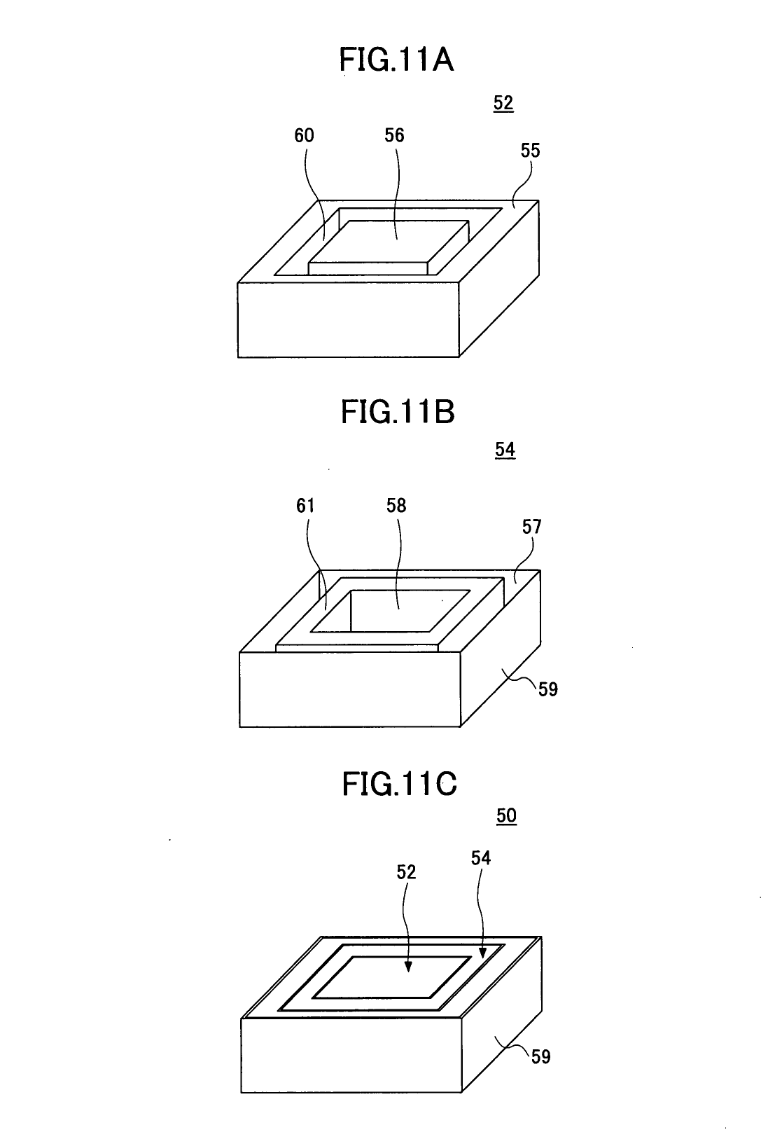

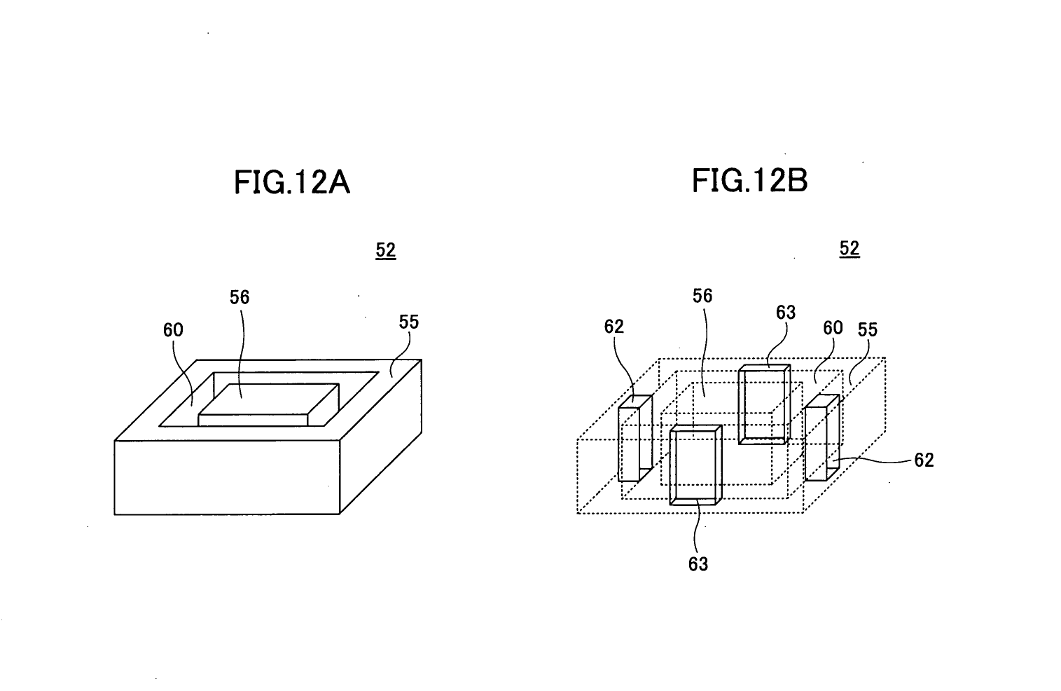

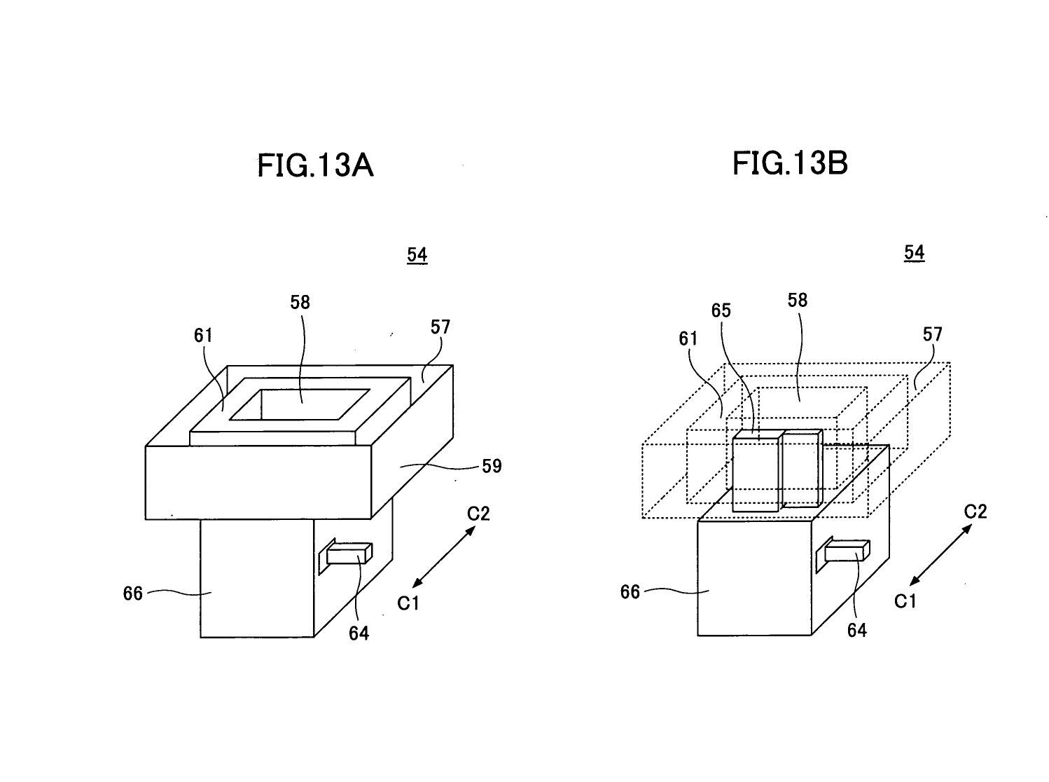

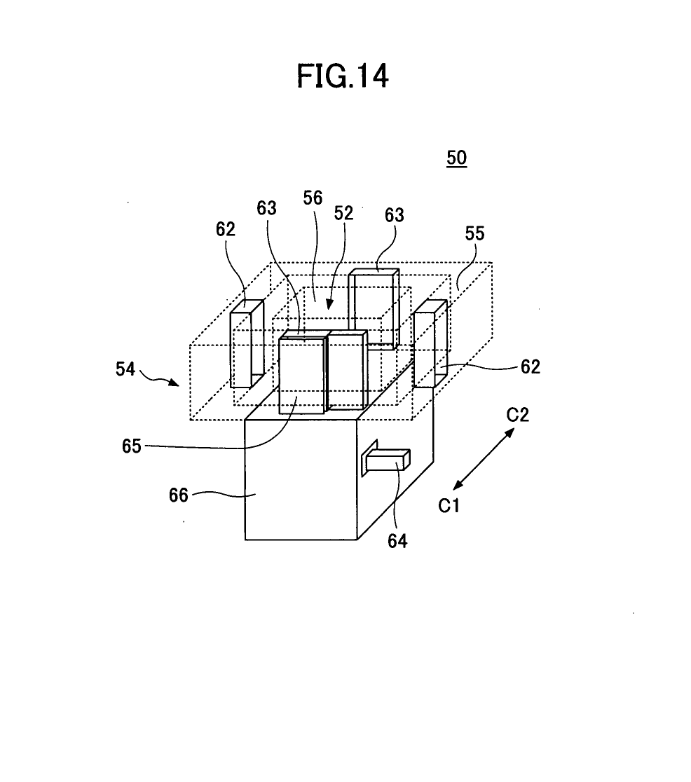

Next, a coupling mechanism 50 according to another embodiment of the present invention is described with reference to FIGS. 10A-14. The coupling mechanism 50 according to this embodiment of the present invention includes a male coupling member 52 (shown in FIGS. 11A, 12A, 12B) and a female coupling member 54 (shown in FIGS. 11B, 13A, 13B).

FIG. 10A is a schematic diagram showing the unit storage member 12 using the coupling mechanism according to an embodiment of the present invention. FIG. 10B is an enlarged view showing a portion of the unit storage member 12 indicated with an arrow B in FIG. 10A. FIG. 10C is an enlarged view showing a portion of the unit storage member 12 indicated with an arrow C in FIG. 10A. FIG. 10D is an enlarged view showing a portion of the unit storage member 12 indicated with an arrow D in FIG. 10A. FIG. 10E is an enlarged view showing a portion of the unit storage member 12 indicated with an arrow E in FIG. 10A.

First, configurations of the male coupling member 52 and the female coupling member 54 according to an embodiment of the present invention are described with reference to FIGS. 11A-14. As shown in FIGS. 11A and 12A, the male coupling member 52 has a first protruding engagement part 55 and a second protruding engagement part 56. The first protruding engagement part 55 is shaped as a frame, and the second protruding engagement part 56 is shaped as a rectangle. The male coupling member 52 has a rectangular frame-shaped groove part 60 formed between the first protruding engagement part 55 and the second protruding engagement part 56.

FIG. 12B is a perspective view of the male coupling member 52. As shown in FIG. 12B, a first pair of locking members (first locking member pair) 62 and a second pair of locking members (second locking member pair) 63 are provided at the outer periphery of the groove part 60 inside the first protruding engagement part 55. In this example, the male coupling member 52 has the first pair locking member 62 facing each other and the second locking member pair 63 facing each other.

In this embodiment of the present invention, the first locking member pair 62 is for ensuring engagement with the female coupling member 54 when the male coupling member 52 is inserted in the female coupling member 54 (described in detail below). The first and second locking member pairs 62, 63 having frame shapes are for engaging a below-described second locking member(s) 65 and locking the engagement between the male coupling member 52 and the female coupling member 54.

Meanwhile, as shown in FIGS. 11B and 13A, the female coupling member 54 has a housing 59 in which a first engagement groove 57, a second engagement groove 58, and a protruding part 61 are formed. The first engagement groove 57 has a shape corresponding to the first protruding engagement part 55 of the male coupling member 52 for engaging the first protruding engagement part 55.

Furthermore, the second engagement groove 58 has a shape corresponding to the second protruding engagement part 56 for engaging the second protruding engagement part 56. Furthermore, the protruding part 61 is configured to engage the groove part 60 formed in the male coupling member 52. Thereby, the male coupling member 52 and the female coupling member 54 can be coupled together.

FIG. 13B is a perspective view showing the female coupling member 54. As shown in FIG. 13B, the second locking member(s) 65 is provided inside the female coupling member 54. The second locking member 65 is connected to a knob part 64 provided in a base 66 below the housing 59. Thus, by moving the knob part 64 in directions C1 and C2, the second locking member 65 can also be moved in directions C1 and C2.

Next, the operation (movement) for coupling the male coupling member 52 and the female coupling member 54 of the coupling mechanism 50 according to an embodiment of the present invention is described. In coupling the male coupling member 52 and the female coupling member 54, proper positioning between the first protruding engagement part 55 and the first engagement groove 57, proper positioning between the second protruding engagement part 56 and the second engagement groove 58, and proper positioning between the protruding part 61 and the groove part 60 are to be established prior to engaging the male coupling member 52 to the female coupling member 54.

In the state where the male coupling member 52 is engaged to the female coupling member 54, one of the second locking member pair 63 of the male coupling member 52 is positioned facing the second locking member 65 of the female coupling member 54. Then, by moving the knob part 64 in direction C1, the second locking member 65 is moved in direction C1, to thereby engage the second locking member 65 to one of the second locking member pairs 63. Although the second locking member 65 in this embodiment of the present invention is illustrated as locking to one of the second locking member pairs 63, the second locking member 65 may be configured to lock not only with the second locking member pair 63 but also with the first locking member pair 62.

Accordingly, the engaging force between the first locking member 63 and the second locking member 65 locks the engagement between the male coupling member 52 and the female coupling member 54. By locking the male coupling member 52 to the female coupling member 54, coupled unit storage members 12 can be prevented from detachment for ensuring engagement. It is to be noted that the coupling between the male coupling member 52 and the female coupling member 54 can be released by performing the above-described procedures in reverse.

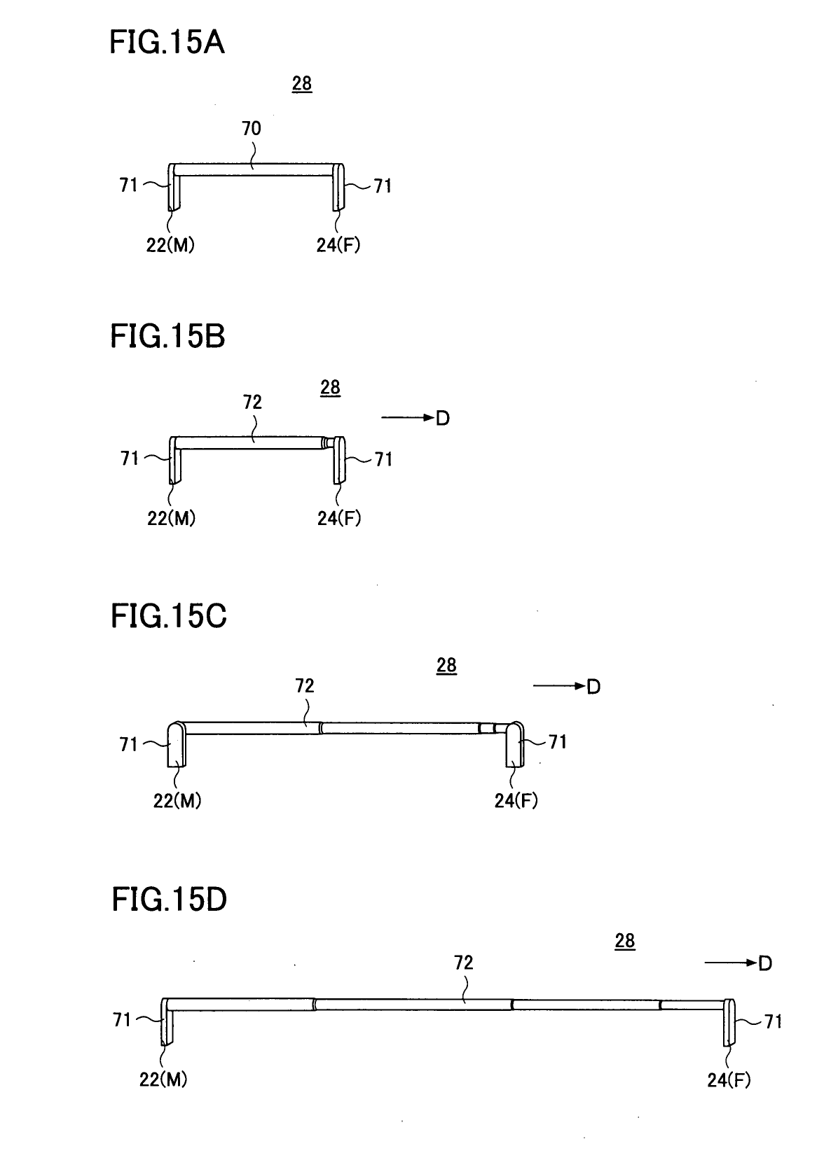

FIGS. 15A through 17C shows exemplary variations of the handle 28 (74) shown in FIGS. 4A and 4B. As shown in FIGS. 15A-15D, the handle 28 includes a grip part 70 and support parts 71. The handle 28 shown in FIG. 15A is a type where the grip part 70 has a fixed length. The support part 71 is provided on both ends of the grip part 70. The male coupling member 22 and the female coupling member 24 are provided on the bottom end of each support part 71. Accordingly, by coupling with the male and female coupling members 22, 24 of the support parts 71 to corresponding male and female coupling members 22, 24 of the coupling mechanism 20 of the unit storage member 12, the handle 28 can be fixed to the unit storage member 12. Likewise, the handle 28 (74) may also be provided with the coupling mechanism 50 including the male and female coupling members 52, 54.

Meanwhile, the handle 28 shown in FIGS. 15B-15D is a type where the grip part 70 can be extended. FIG. 15B shows the handle 28 in a state before the grip part 70 is extended, FIG. 15C shows the handle 28 in a state where the grip part 70 is extended to the second level, and FIG. 15D shows the handle 28 in a state where the grip part 70 is extended to the third level. Therefore, even if the unit storage member 12 is coupled to an arbitrary number of unit storage members 12, the handle 28 can be used for accommodating different coupling variations owing to the extendable configuration of the grip part 70.

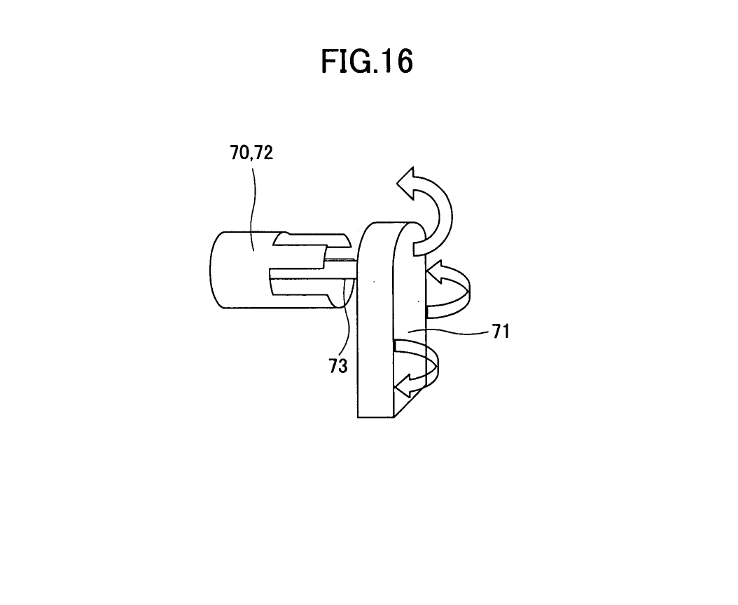

FIG. 16 shows a joint member 73 used at the connecting portion between the support part 71 and the grip part 72 (70). For example, the joint member 73 may be a ball joint type member. In a case where the ball joint type member is used as the joint member 73, the position of the grip part 72 (70) can be moved (rotated) with respect to the support part 71, to thereby enhance the degree of freedom with respect to the unit storage member 12. More specifically, as shown in FIG. 16, the grip part 72 (70) has grooves formed at its ends part for allowing the handle 28 to swing 180 degrees in a horizontal direction (left and right directions) and 90 degrees in a vertical direction (up and down directions).

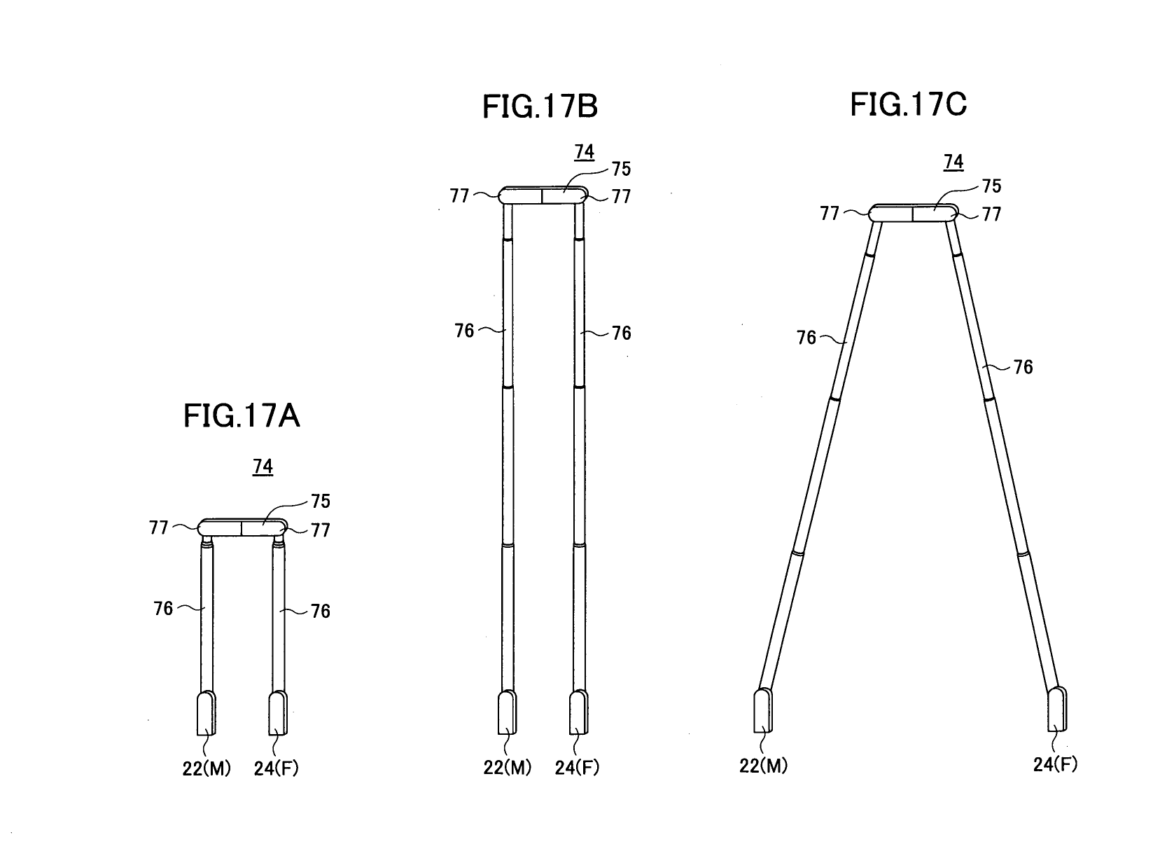

The handle 74 shown in FIGS. 17A-17C is a type having extendable support parts 76. It is to be noted that, although the handle 74 shown in FIGS. 17A-17C are illustrated as a united body (for the sake of convenience), the handle 74 according to an embodiment of the present invention may be configured having two of the above-described handles 28 attached to each other. Thus, in this configuration, the above-described support part 71 is substantially the same as the below-described joint member 77 which also has male/female connecting members 22, 24 provided at its ends. FIG. 17A shows the handle 74 in a state before the support parts 76 are extended and FIG. 17B shows the handle 74 in a state where the support parts 76 are extended to the third level. Accordingly, the length of the handle 74 can be adjusted in accordance with, for example, the height of the user, to thereby enhance the usability of the modular bag. Furthermore, by using joint members 77 at the connecting portion between the support parts 76 and the handle 74, the handle 74 can be used in a manner forming a trapezoidal shape as shown in FIG. 17C for further enhancing the degree of freedom during use.

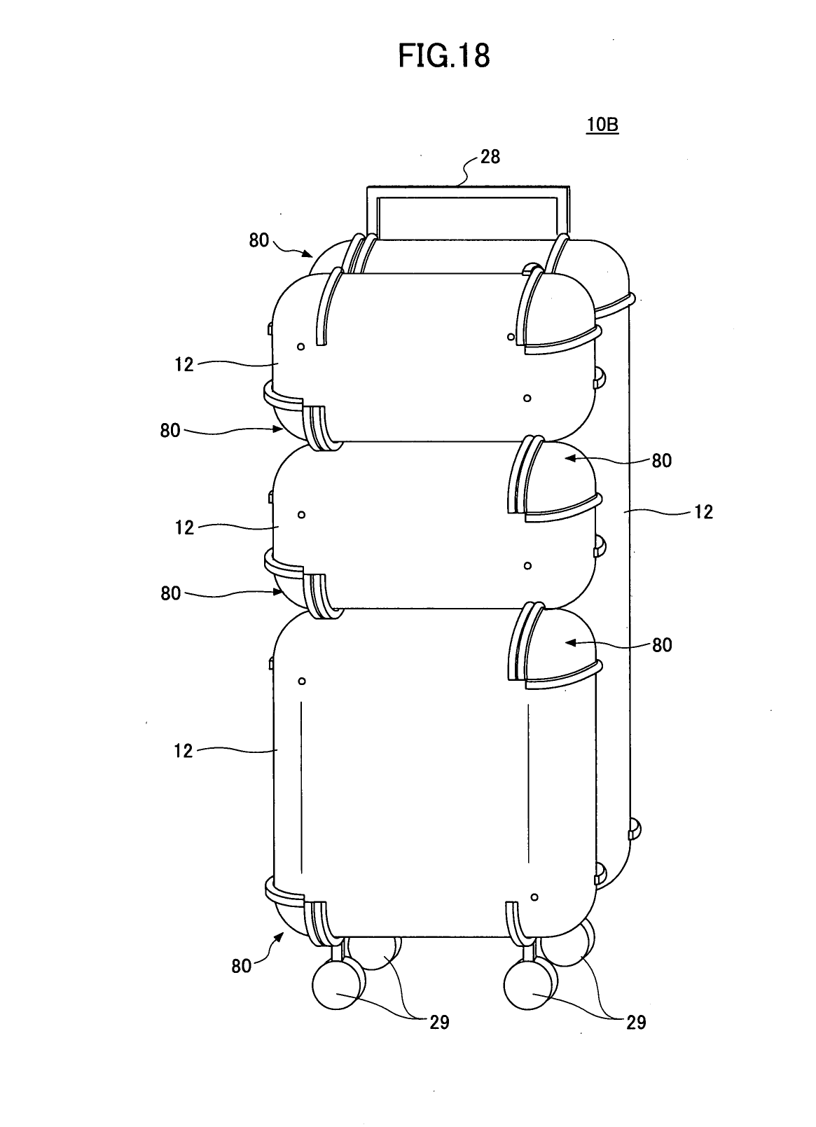

FIGS. 18 to 22 show a modular bag 10B according to a second embodiment of the present invention.

FIG. 18 shows a detail example of the modular bag 10B according to a second embodiment of the present invention. In the example shown in FIG. 18, four unit storage members 12 are coupled together by a coupling mechanism 80. Furthermore, in addition to providing the handle 28 at the upper part of the modular bag 10B, rollers 29 are provided at the lower part of the modular bag 10B.

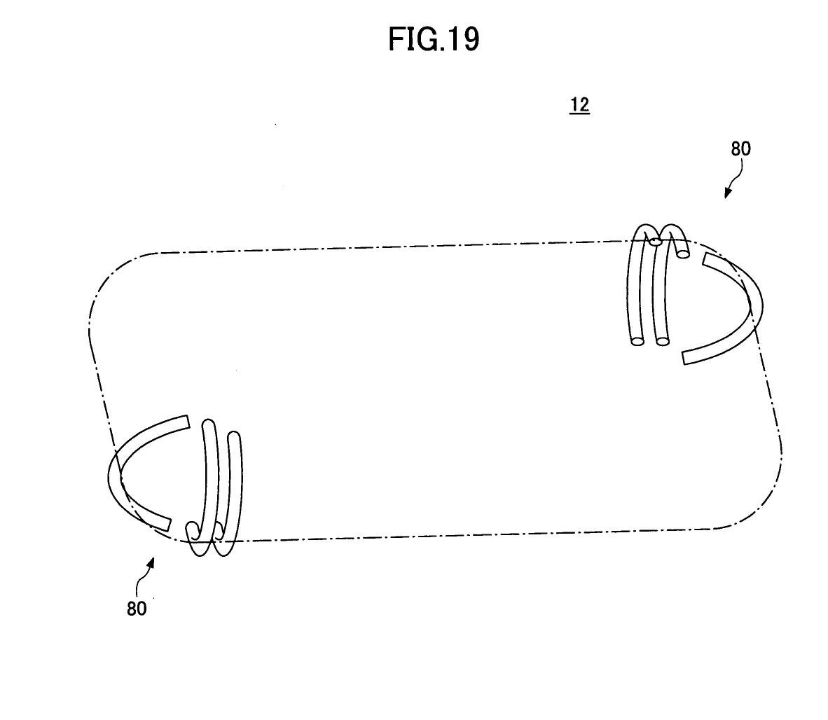

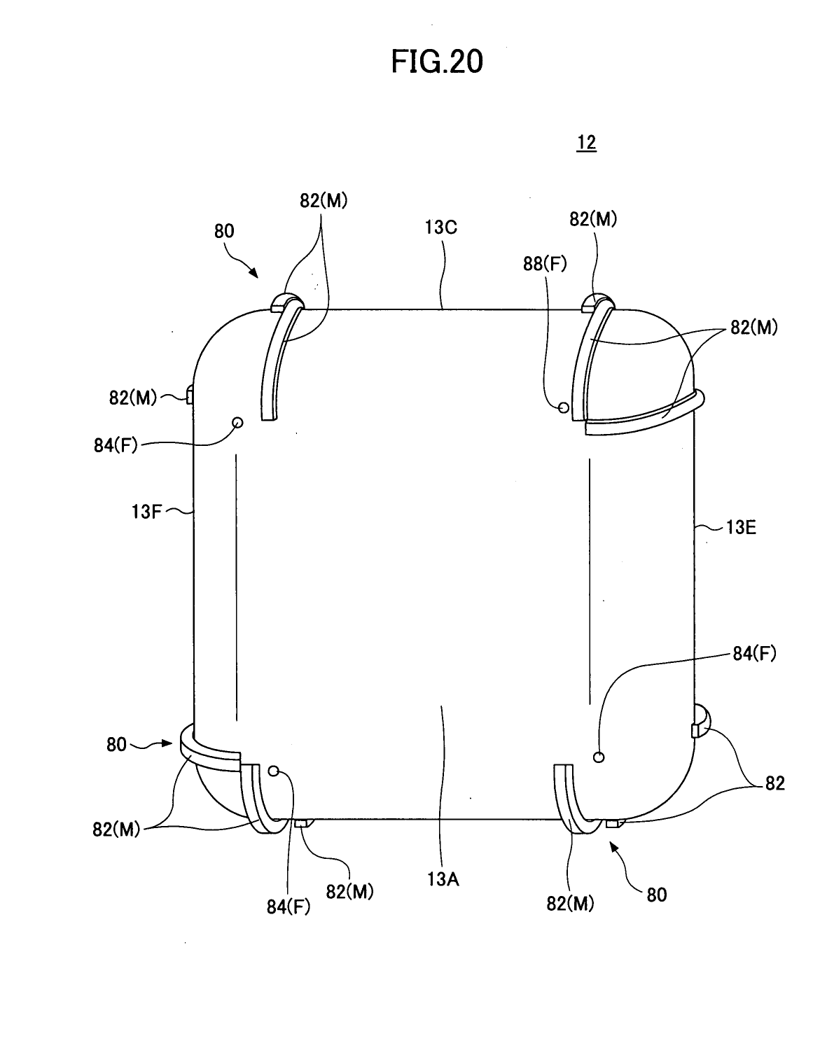

FIGS. 19 and 20 are enlarged views showing exemplary variations of the unit storage member 12. Compared to the above-described embodiments of the present invention, the unit storage member 12 according to this embodiment of the present invention has a curved outer shape. Furthermore, the coupling mechanism 80 is provided to each corner part of the unit storage module 12. In addition, as described in detail below, the exemplary variation of the unit storage member 12 shown in FIG. 19 may be configured differently from the exemplary variation of the unit storage member 12 shown in FIGS. 18 and 20 in that i) the cross-section of the male coupling member 82 has a circular cross-section (instead of a square/rectangular cross-section), ii) the length of the male coupling member 82 is configured to accommodate rotary attachment of 180 degrees (instead of 90 degrees), and iii) the male coupling member 82 can also be hinged at its center (instead of at one or both of its ends).

The coupling mechanism 80 also has a male coupling member 82 and a female coupling member 84. In this example, the male coupling member 82 has a cord-like shape. As shown in FIG. 19, the male coupling member 82 is fixed to the modular bag 12 by a hinge part provided at its center portion. Both end parts of the male coupling member 82 are free ends. In a state where the unit storage members 12 are not coupled to each other, both end parts of the male coupling member 82 are engaged to engagement parts (not shown) of the unit storage member 12. Meanwhile, in a case of coupling with another unit storage member 12, both end parts of the male coupling member 82 are coupled to the female coupling member 84 of the coupling mechanism 80 of the other unit storage member 12.

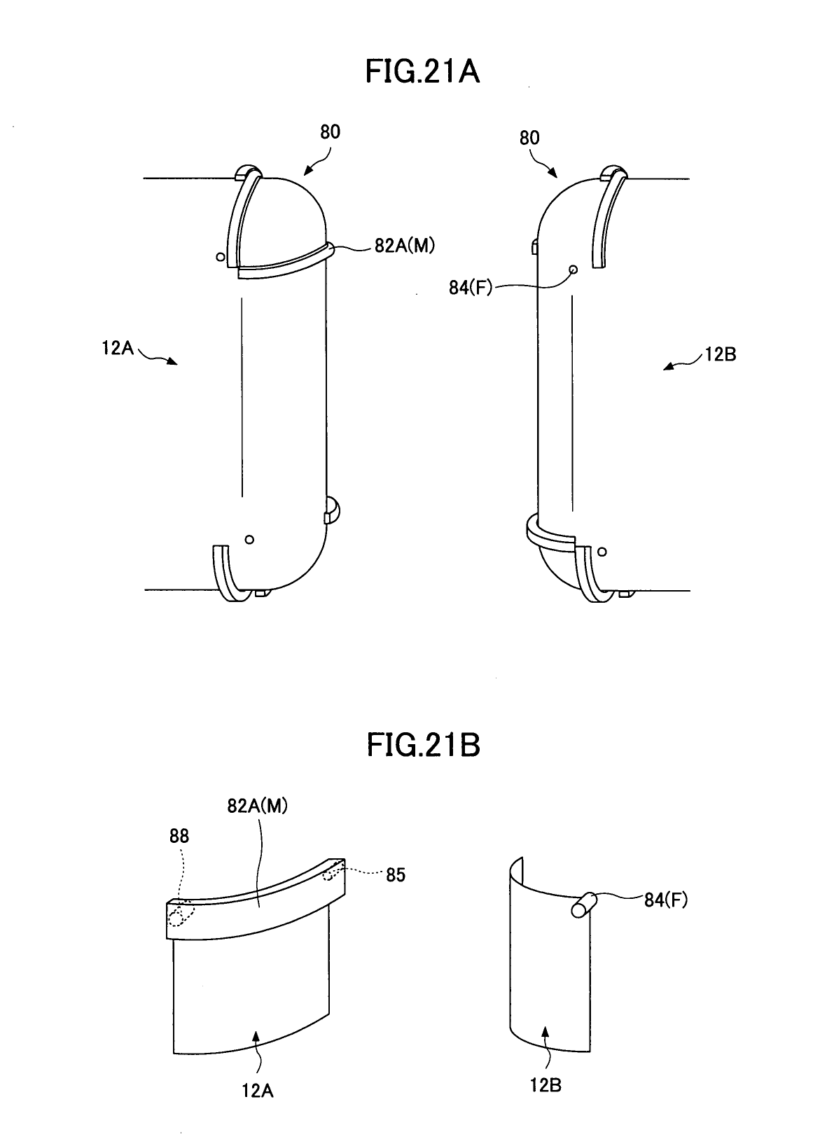

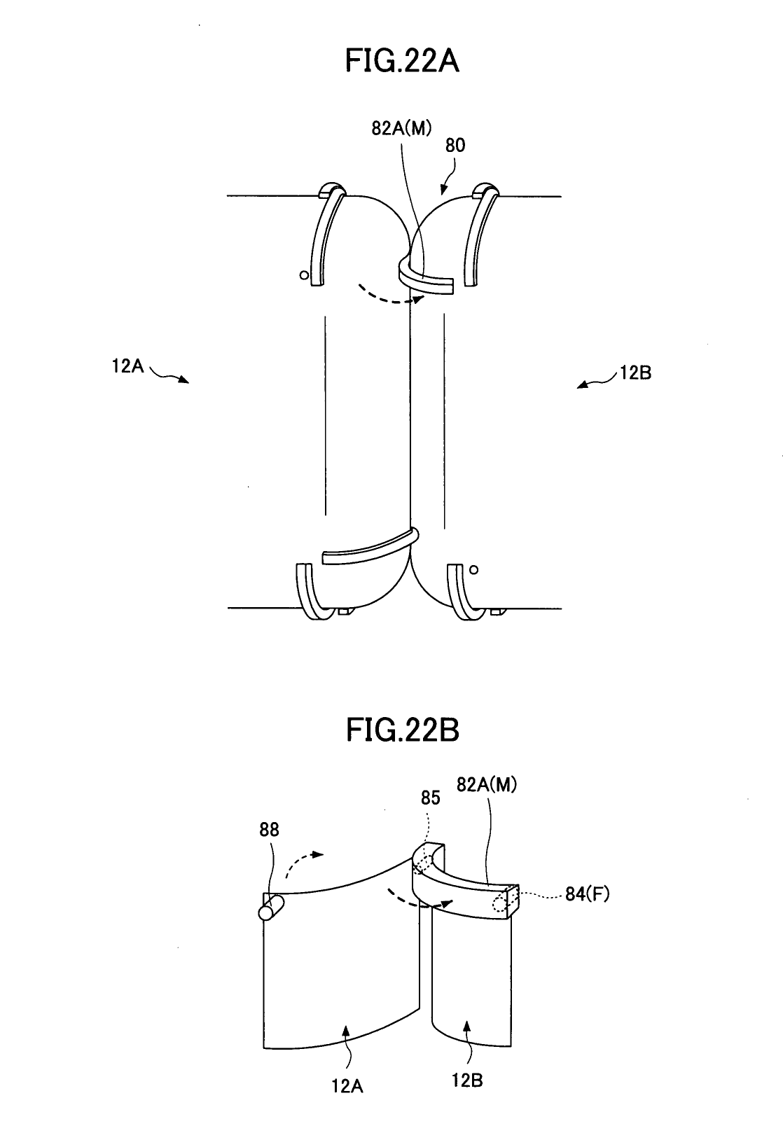

FIG. 20 shows an exemplary configuration where one end part of the male coupling member 82 is fixed to the hinge part 85 (shown in FIGS. 21B and 22B) while the other end part of the male coupling member 82 is a free end. In a case where the unit storage members 12 are not coupled together, the other end part is engaged to the engagement part (not shown) of the unit storage member 12. In a case of where the unit storage members 12 are coupled together, the other end part is coupled to the female coupling member 84 of the coupling mechanism 80 of the other unit storage member 12.

Next, the operation (movement) for coupling a unit storage member 12A to another unit storage member 12B is described. FIGS. 21A and 21B are schematic diagrams showing an exemplary case of coupling the unit storage member 12A and the unit storage member 12B. For the sake of convenience, an operation of the male coupling member 82A in a case of coupling the unit storage members 12A, 12B in the horizontal direction is described below.

As shown in FIG. 21, in the state where the unit storage member 12A and the unit storage member 12B are not coupled, the male coupling member 82A is engaged to an engagement member 88 of the unit storage member 12A while the female coupling member 84 of the unit storage member 12B is not coupled to any member. In this state, the unit storage member 12A and the unit storage member 12B are positioned adjacent to each other. Then, the male coupling member 82A of the unit storage member 12A is coupled to the female coupling member of the unit storage member 12B.

More specifically, the free end part of the male coupling member 82A is detached from the engagement member 88 and pivotally moved with respect to the hinge 85. By detaching the cord-like male coupling member 82A from the engagement member 88, the male coupling member 82A becomes movable. Accordingly, the end part of the male coupling member 82A can be coupled to the female coupling member 84. Thus, as shown in FIGS. 22A and 22B, the end part of the male coupling member is coupled to the female coupling member 84 in a manner where the male coupling member 84 is wrapped around the unit storage member 12B. Thereby, the unit storage member 12A and the unit storage member 12B can be coupled together by the coupling mechanism 80 having the male coupling member 82A and the female coupling member 84.

Hence, in the above-described embodiments of the present invention, reliable coupling can be ensured even where the outer shape of the unit storage members is curved instead of square, the unit storage member 12A and 12B can be coupled together by using the cord-like male coupling member 82A. Since the male coupling member 82 (82A) is formed with a material having high tensile strength (e.g., leather, high ductility resin), the unit storage member 12A and the unit storage member 12B can be reliably coupled even if the male coupling member 82 (82A) has a cord-like configuration.

Further, the present invention is not limited to these embodiments, but variations and modifications may be made without departing from the scope of the present invention.

For example, although the modular assembly according to the above-described embodiments of the present invention is described by using an example of a modular bag, the modular assembly of the present invention may also be applied to, for example, kitchen containers, storage boxes, toys, shelves, partitions (e.g., units separating one area from another in homes and offices), and electronic peripherals (e.g., boxes or containers for storing CD, DVD, audio visual equipment, computers, cameras, phones, etc.).

What is claimed is:

1. A modular assembly comprising:
a plurality of unit storage members for storing an object therein, each unit storage member substantially having six sides and eight corner parts, each unit storage member including a coupling mechanism having a male coupling member and a female coupling member dedicated to couple with the male coupling member;
wherein the plural unit storage members are coupled by having the male coupling member of one unit storage member coupled to the female coupling member of another unit storage member situated adjacent to the one unit storage member,
wherein among sets of three sides that form each of the corner parts of the unit storage member, each unit storage member includes a first corner part formed by having one male coupling member provided on one side and one female coupling member provided on each of the other two sides and a second corner part formed by having one female coupling member provided on one side and one male coupling member provided on each of the other two sides,
wherein the first and second corner parts are arranged in a manner having coupling members of the same kind positioned diagonally opposite to each other.

2. The modular assembly as claimed in claim 1, wherein the male coupling member includes a protruding engagement part, wherein the female coupling member includes an engagement groove into which the protruding engagement member is engaged.

3. The modular assembly as claimed in claim 2, wherein the male coupling member includes a first locking member, wherein the female coupling member includes a second locking member movable to a position engaging the first locking member and a knob part operable to move the second locking member to the engaging position.

4. The modular assembly as claimed in claim 1, wherein the male coupling member includes a cantilevered arm part having a pawl part one end and a knob part on the other end, wherein the female coupling member includes a locking member for engaging the pawl part.

5. The modular assembly as claimed in claim 4, wherein the knob part is operable to engage and disengage the pawl part with respect to the locking member.

6. The modular assembly as claimed in claim 1, wherein the male coupling member includes an insertion engagement member having a tapered shape, wherein the female coupling member includes an engagement opening into which the insertion engagement member is engaged.

7. The modular assembly as claimed in claim 1, further comprising:
a handle having the male coupling member on one end and the female coupling member on the other end.

8. The modular assembly as claimed in claim 7, wherein the handle is extendible.

9. The modular assembly as claimed in claim 1, further comprising:
a pair of rollers provided to the male coupling member or the female coupling member.

10. A modular assembly comprising:
a plurality of unit storage members for storing an object therein, each unit storage member including a coupling mechanism having a male coupling member and a female coupling member dedicated to couple with the male coupling member;
wherein the plural unit storage members are coupled by having the male coupling member of one unit storage member coupled to the female coupling member of another unit storage member situated adjacent to the one unit storage member,
wherein at least one of the male coupling member and the female coupling member has a cord-like shape having one end connected to the one unit storage member and the other end is detachably attachable to the other unit storing member.
